(19) United States
(12) Patent Application Publication
(10) Pub. No.: US 2025/0133336 A1
(43) Pub. Date: Apr. 24, 2025

(54) WRIST-WORN DEVICE AND AIR PRESSURE ADJUSTMENT METHOD, APPARATUS AND SYSTEM THEREOF

(71) Applicant: GOERTEK INC., Weifang, Shandong (CN)

(72) Inventors: Bo YAN, Weifang, Shandong (CN); Tingting XU, Weifang, Shandong (CN)

(21) Appl. No.: 18/694,459

(22) PCT Filed: Dec. 16, 2021
(86) PCT No.: PCT/CN2021/138751

§ 371 Date: Mar. 22, 2024

(30) Foreign Application Priority Data
Nov. 30, 2021 (CN) 202111442592.9

(51) Int. Cl. H04R 1/38; H04R 1/02

(52) U.S. Cl. CPC H04R 1/38; H04R 1/025; H04R 2201/023

(57) ABSTRACT

Disclosed is a wrist-worn device and air pressure adjustment method, apparatus and system thereof. The method includes: controlling a speaker of the wrist-worn device to emit a first sound (S110); receiving a sound signal picked up by a microphone, and analyzing the sound signal to obtain a corresponding amplitude value (S120); and determining whether the amplitude value is less than a preset amplitude threshold (S130), and if so, performing pressure relief process of a rear cavity of the speaker, so that the rear cavity of the speaker maintains air pressure balance (S140), thereby ensuring that the speaker can operate normally, and is advantageous in improving the user experience.

This application claims priority to the Chinese Patent Application No. 202111442592.9, entitled “wrist-worn device and air pressure adjustment method, apparatus and system thereof”, filed with the China Patent Office on Nov. 30, 2021, all contents of which are incorporated into herein by reference.

### TECHNICAL FIELD

The present disclosure relates to the technical field of wrist-worn device, and particularly, to a wrist-worn device and air pressure adjustment method, apparatus, and system thereof.

### BACKGROUND

In recent years, wrist-worn devices, such as smart watches, have become more and more popular. Wrist-worn devices have begun to develop in the directions of smart calls, health monitoring, medical warnings, and the Internet of Everything. 5 ATM and 10 ATM waterproofing have also begun to become the standard for wrist-worn devices. A big problem caused by high waterproof level is that the cavity of the whole of the wrist-worn device has poor air permeability. Here, the cavity of the whole device is the rear cavity of the speaker, the rear cavity is equipped with an air pressure balance hole, and this hole is equipped with a waterproof and breathable membrane. The higher the waterproof level, the smaller the air permeability of the balanced breathable hole. For high waterproof levels (generally above 50 m waterproof), the air permeability of the balanced breathable hole in the rear cavity of the speaker is smaller, because the normal operation of the speaker requires air pressure balance. Therefore, when the internal air pressure of the product increases due to high temperature or other factors, the air pressure in the rear cavity will also increase. Due to the small air permeability of the balanced ventilation hole, a bulge may appear on the diaphragm of the speaker, causing low sound or even damage on the speakers, which seriously affects the user's experience.

In view of above, how to provide a wrist-worn device and air pressure adjustment method, apparatus, and system thereof that solve the above technical problems has become a problem that those skilled in the art need to solve.

### SUMMARY

A purpose of an embodiment of the present disclosure is to provide a wrist-worn device and air pressure adjustment method, apparatus, and system thereof, which may be advantageous in maintaining air pressure balance of the rear cavity of the speaker during use to ensure that the speaker can work normally, facilitating the improvement of the user experience.

In order to solve the above technical problem, an embodiment of the present disclosure provides an air pressure adjustment method for a wrist-worn device, applied to the wrist-worn device, the method comprising:
controlling a speaker of the wrist-worn device to emit a first sound;
receiving a sound signal picked up by a microphone, and analyzing the sound signal to obtain a corresponding amplitude value;
determining whether the amplitude value is less than a preset amplitude threshold, and if so, performing a pressure relief process of a rear cavity of the speaker.

Optionally, performing the pressure relief process of the rear cavity of the speaker comprises:
controlling the speaker to emit a low-frequency sound, so that a displacement of a diaphragm of the speaker reaches a preset value to relieve pressure in the rear cavity of the speaker.

Optionally, before controlling the speaker of the wrist-worn device to emit the first sound, the method further comprises:
determining whether an audio system of the wrist-worn device is in an idle state, and if so, performing controlling the speaker of the wrist-worn device to emit the first sound.

Optionally, controlling the speaker of the wrist-worn device to emit the first sound comprises:
controlling the speaker of the wrist-worn device to emit the first sound having a frequency band in a low-frequency non-audible band.

Optionally, controlling the speaker to emit the low-frequency sound, so that the displacement of the diaphragm of the speaker reaches the preset value comprises:
controlling the speaker to emit the low-frequency sound having a frequency band in a low-frequency non-audible frequency band, so that the displacement of the diaphragm of the speaker reaches the preset value.

Optionally, determining whether the amplitude value is less than the preset amplitude threshold comprises:
determining a target preset amplitude threshold according to a current volume of the speaker based on a pre-established correspondence between a volume of the speaker and the preset amplitude threshold;
determining whether the amplitude value is less than the target preset amplitude threshold.

Optionally, controlling the speaker of the wrist-worn device to emit the first sound comprises:
after receiving a command to turn on a pressure relief mode, controlling the speaker of the wrist-worn device to emit the first sound.

An embodiment of the present disclosure further provides air pressure adjustment apparatus for a wrist-worn device, applied to the wrist-worn device, the apparatus comprising:
a control module for controlling a speaker of the wrist-worn device to emit a first sound;
an analysis module for receiving a sound signal picked up by a microphone, and analyzing the sound signal to obtain a corresponding amplitude value;
a first determination module for determining whether the amplitude value is less than a preset amplitude threshold, and if so, activating a pressure relief module; and
the pressure relief module for performing a pressure relief process of a rear cavity of the speaker.

An embodiment of the present disclosure further provides an air pressure adjustment system for a wrist-worn device, applied to the wrist-worn device, the system comprising:
a memory configured to store a computer program; and
a processor configured to implement, when executing the computer program, the air pressure adjustment method of the wrist-worn device as described above.

An embodiment of the present disclosure further provides a wrist-worn device comprising a speaker, a microphone and the air pressure adjustment system of the wrist-worn device as described above.

An embodiment of the present disclosure provides a wrist-worn device and air pressure adjustment method, apparatus and system thereof, the method comprising: controlling a speaker of the wrist-worn device to emit a first sound; receiving a sound signal picked up by a microphone, and analyzing the sound signal to obtain a corresponding amplitude value; and determining whether the amplitude value is less than a preset amplitude threshold, and if so, performing a pressure relief process of a rear cavity of the speaker.

It can be seen that the wrist-worn device according to the present disclosure can control the speaker to emit the first sound during use, and after picking up the sound signal through the microphone, analyze the sound signal to obtain the corresponding amplitude value, and then determine whether the amplitude value is smaller than the preset amplitude threshold. When it is less than the preset amplitude threshold, it means that the air pressure in the rear cavity of the speaker is large, which may affect the sound performance of the speaker. In this case, the pressure in the rear cavity of the speaker is relieved to promote the air in the rear cavity of the speaker to be discharged from the air pressure balance hole, so as to maintain the air pressure balance of the rear cavity of the speaker, ensuring that the speaker can work normally, advantageous in improving the user experience.

### BRIEF DESCRIPTION OF DRAWINGS

In order to explain the technical solutions in the embodiments of the present disclosure more clearly, the prior art and the drawings needed to be used in the embodiments will be briefly introduced below. Obviously, the drawings in the following description are only some of the drawings of the present disclosure. Embodiments, for those of ordinary skill in the art, other drawings can also be obtained based on these drawings without exerting creative efforts.

FIG. 1 is a schematic flow chart of an air pressure adjustment method for a wrist-worn device according to an embodiment of the present disclosure; and

FIG. 2 is a schematic structural diagram of an air pressure adjustment apparatus for a wrist-worn device according to an embodiment of the present disclosure.

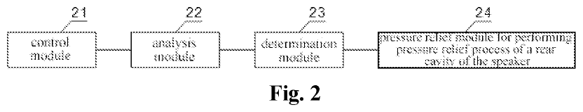

### DETAILED DESCRIPTIONS

Embodiments of the present disclosure provide a wrist-worn device and air pressure adjustment method, apparatus and system thereof. which may be advantageous in maintaining air pressure balance of the rear cavity of the speaker during use to ensure that the speaker can work normally, facilitating the improvement of the user experience.

In order to make purposes, technical solutions and advantages of the embodiments of the present disclosure clearer, the technical solutions in the embodiments of the present disclosure will be clearly and completely described below in conjunction with the drawings in the embodiments of the present disclosure. Obviously, the described embodiments These are some embodiments of the present disclosure, rather than all embodiments. Based on the embodiments of the present disclosure, all other embodiments obtained by those of ordinary skill in the art without creative efforts fall within the scope of protection of the present disclosure.

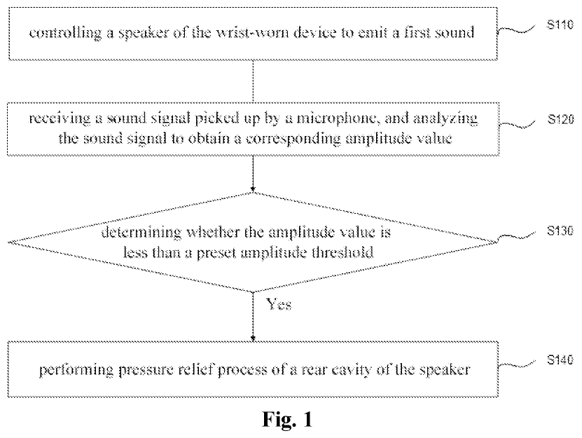

Please refer to FIG. 1, which is a schematic flow chart of an air pressure adjustment method for a wrist-worn device according to an embodiment of the present disclosure. The method includes:
S110: Controlling the speaker of the wrist-worn device to emit the first sound.

It should be noted that the embodiments of the present disclosure may be applicable to wrist-worn devices with waterproof functions. For wrist-worn devices with high waterproof levels, due to the small ventilation capability of the air pressure balance hole in the rear cavity, the bulge phenomenon may occur, which affects the speaker performance. Therefore, in the embodiment of the present disclosure, the air pressure in the rear cavity of the speaker of the wrist-worn device can be determined first to determine whether the air pressure is large. Specifically, the first sound can be emitted by controlling the speaker of the wrist-worn device. In order to improve the user experience and avoid causing interference to the user, the speaker of the wrist-worn device can be controlled to emit the first sound with a frequency in the low-frequency non-audible band. For example, the speaker can emit a first sound corresponding to a single-frequency signal in the low-frequency non-audible band at rated power.

S120: Receiving the sound signal picked up by the microphone, and analyzing the sound signal to obtain the corresponding amplitude value.

Specifically, after the speaker is controlled to emit the first sound, the microphone is controlled to pick up the first sound to obtain the corresponding sound signal, and then the amplitude value corresponding to the sound signal is obtained by analyzing the sound signal.

S130: Determining whether the amplitude value is less than the preset amplitude threshold and if so, proceeding to step S140.

S140: Performing a pressure relief process of the rear cavity of the speaker.

Specifically, after obtaining the amplitude value of the sound signal picked up by the microphone, the amplitude value can be compared with the preset amplitude threshold. When the amplitude value is less than the preset amplitude threshold, it means that the air pressure in the rear cavity of the speaker is high and it has affected the sound performance of the speaker. Therefore, it is necessary to relieve the pressure in the rear cavity of the speaker to promote the air in the rear cavity of the speaker to be discharged from the air pressure balance hole, so as to maintain the balance of the air pressure in the rear cavity of the speaker and improve the performance of the speaker and the wrist-worn device as well as user experience.

Furthermore, the above-mentioned step S140 of performing a pressure relief process of the rear cavity of the speaker includes:
Controlling the speaker to emit a low-frequency sound, so that a displacement of a diaphragm of the speaker reaches a preset value to relieve pressure in the rear cavity of the speaker.

It should be noted that because the displacement of the speaker diaphragm is relatively larger when the speaker emits low-frequency sound, it can promote the air vibration inside the rear cavity of the speaker to a greater extent, promote the circulation of air in the rear cavity, and speed up the discharge of air from the air pressure balance hole. In this way, the pressure in the rear cavity of the speaker can be relieved and the air pressure in the rear cavity of the speaker can be balanced. Specifically, in the embodiment of the present disclosure, the speaker can be controlled to emit low-frequency sound, and the displacement of the diaphragm of the speaker can reach the preset value. Specifically, the displacement of the diaphragm can reach the preset displacement. The specific value of the preset displacement can be determined according to actual needs in order to realize the pressure relief from the rear cavity of the speaker. Specifically, the speaker can be controlled to emit low-frequency sound in a low-frequency non-audible frequency band (for example, less than 50 Hz).

Further, before the above-mentioned step S110 of controlling the speaker of the wrist-mounted device to emit the first sound, the method may also include:
Determining whether the audio system of the wrist-worn device is in an idle state, and if so, performing controlling the speaker of the wrist-worn device to emit the first sound.

Specifically, in order to further avoid impact on the user's use, in the embodiment of the present disclosure, it may be first determined whether the audio system of the wrist-worn device is in an idle state, and if the audio system is in the idle state, the speaker of the wrist-worn device is controlled to emit the first sound. Further, the air pressure in the rear cavity of the speaker is determined, and when the air pressure is high, pressure relief process of the rear cavity of the speaker is performed.

In addition, in practical applications, the speaker of the wrist-worn device can be controlled to emit the first sound after receiving the command to turn on the pressure relief mode. In this case, whether the audio system of the wrist-worn device is in the idle state can be determined after receiving the command to turn on the pressure relief mode. When it is in the idle state, the speaker of the wrist-worn device is controlled to emit the first sound.

Furthermore, controlling the speaker to emit low-frequency sound, so that the displacement of the diaphragm of the speaker reaches the preset value includes:
Controlling the speaker to emit the low-frequency sound having a frequency band in a low-frequency non-audible frequency band, so that the displacement of the diaphragm of the speaker reaches the preset value.

Specifically, in the embodiment of the present disclosure, in order to prevent the impact on the user during the pressure relief process of the rear cavity of the speaker is performed, the speaker can be controlled to emit low-frequency sound in the low-frequency non-audible frequency band, so that the displacement of the diaphragm of the speaker reaches the preset value. In addition, the speaker can also be controlled to periodically emit low-frequency sounds in the low-frequency non-audible frequency band. Specifically, the number of cycles can be preset (e.g., 5 cycles). When the number of cycles is reached, the next round of detection can be proceeded until the detected amplitude value of the sound signal is greater than or equal to the preset amplitude threshold.

Further, the step S130 of determining whether the amplitude value is less than the preset amplitude threshold may include:
Determining a target preset amplitude threshold according to a current volume of the speaker based on a pre-established correspondence between a volume of the speaker and the preset amplitude threshold; and
Determining whether the amplitude value is less than the target preset amplitude threshold.

It can be understood that since the amplitudes of sounds played at different volumes are different, in the embodiment of the present disclosure, a preset amplitude threshold corresponding to each volume can be established in advance according to the volume of the speaker, and after the corresponding amplitude value is obtained based on the sound signal picked up by the microphone, the preset amplitude threshold corresponding to the current volume is then determined based on the current volume of the speaker. Then, it is determined whether the amplitude value is less than the target preset amplitude threshold, that is, the amplitude value is compared with the corresponding preset amplitude threshold. When the amplitude value is less than the preset amplitude threshold, perform a pressure relief process of the rear cavity of the speaker.

It can be seen that the wrist-worn device in the present disclosure can control the speaker to emit the first sound during use, and after picking up the sound signal through the microphone, analyze the sound signal to obtain the corresponding amplitude value, and then determine whether the amplitude value is smaller than the preset amplitude threshold. If it is less than the preset amplitude threshold, it means that the air pressure in the rear cavity of the speaker is large, which may affect the sound performance of the speaker. At this time, the pressure in the rear cavity of the speaker is relieved to promote the air in the rear cavity of the speaker to be discharged from the air pressure balance hole, so as to maintain the air pressure balance of the rear cavity of the speaker, ensuring that the speaker can work normally and is advantageous in improving the user experience.

In addition to the above embodiments, an embodiment of the present disclosure provides air pressure adjustment apparatus for the wrist-worn device, the apparatus including:
A control module 21 for controlling a speaker of the wrist-worn device to emit a first sound;
An analysis module 22 for receiving a sound signal picked up by a microphone, and analyzing the sound signal to obtain a corresponding amplitude value;
A determination module 23 for determining whether the amplitude value is less than a preset amplitude threshold, and if so, activating a pressure relief module 24; and
The pressure relief module 24 for performing a pressure relief process of a rear cavity of the speaker.

It should be noted that the air pressure adjustment apparatus for the wrist-worn device in the embodiment of the present disclosure has the same beneficial effects as the air pressure adjustment method for the wrist-worn device provided in the above embodiments, and is also applicable to the wrist-worn device according to the embodiment of the present disclosure. For a detailed introduction to the air pressure adjustment method of the equipment, please refer to the above embodiment, and the present disclosure will not be described in detail here.

On another aspect, an embodiment of the present disclosure provides an air pressure adjustment system for the wrist-worn device, the device including:
A memory configured to store a computer program;
A processor configured to implement the air pressure adjustment method of the wrist-worn device as described above when executing the computer program.

For example, the processor according to the embodiment of the present disclosure can be configured to control the speaker of the wrist-worn device to emit the first sound; to receive the sound signal picked up by the microphone, and analyze the sound signal to obtain the corresponding amplitude value; and to determine whether the amplitude value is less than the preset amplitude threshold and if so, perform the pressure relief process of the rear cavity of the speaker.

In addition to the above embodiments, an embodiment of the present disclosure provides a wrist-worn device, including a speaker, a microphone, and the above-mentioned air pressure adjustment system for the wrist-worn device.

Each embodiment in this specification is described in a progressive manner. Each embodiment focuses on its differences from other embodiments. The same and similar parts between the various embodiments can be referred to each other. As for the device disclosed in the embodiment, since it corresponds to the method disclosed in the embodiment, the description is relatively simple. For relevant details, please refer to the description in the method section.

It should also be noted that in this specification, relational terms such as first and second are only used to distinguish one entity or operation from another entity or operation, and do not necessarily require or imply that these entities or operations include such actual relationship or sequence to each other. Furthermore, the terms “comprise,” “include,” or any other variations thereof are intended to cover a non-exclusive inclusion such that a process, method, article, or apparatus that includes a list of elements includes not only those elements, but also those not expressly listed other elements, or elements inherent to the process, method, article or equipment. Without further limitation, an element defined by the statement “comprises a . . . ” does not exclude the presence of additional identical elements in a process, method, article, or apparatus that includes the stated element.

The above description of the disclosed embodiments enables those skilled in the art to make or use the present disclosure. Various modifications to these embodiments will be readily apparent to those skilled in the art, and the generic principles defined herein may be practiced in other embodiments without departing from the spirit or scope of the invention. Thus, the present disclosure is not intended to be limited to the embodiments shown herein but is to be accorded the widest scope consistent with the principles and novel features disclosed herein.

1. An air pressure adjustment method for a wrist-worn device, applied to the wrist-worn device, the air pressure adjustment method comprising:
controlling a speaker of the wrist-worn device to emit a first sound;
receiving a sound signal picked up by a microphone, and analyzing the sound signal to obtain a corresponding amplitude value; and
determining whether the amplitude value is less than a preset amplitude threshold, and if so, performing a pressure relief process of a rear cavity of the speaker.

2. The air pressure adjustment method of the wrist-worn device according to claim 1, wherein performing the pressure relief process of the rear cavity of the speaker comprises:
controlling the speaker to emit a low-frequency sound, so that a displacement of a diaphragm of the speaker reaches a preset value to relieve pressure in the rear cavity of the speaker.

3. The air pressure adjustment method of the wrist-worn device according to claim 1, wherein, before controlling the speaker of the wrist-worn device to emit the first sound, the method further comprises:
determining whether an audio system of the wrist-worn device is in an idle state, and if so, performing controlling the speaker of the wrist-worn device to emit the first sound.

4. The air pressure adjustment method of the wrist-worn device according to claim 1, wherein controlling the speaker of the wrist-worn device to emit the first sound comprises:
controlling the speaker of the wrist-worn device to emit the first sound having a frequency band in a low-frequency non-audible band.

5. The air pressure adjustment method of the wrist-worn device according to claim 2, wherein controlling the speaker to emit the low-frequency sound, so that a displacement of a diaphragm of the speaker reaches the preset value comprises:
controlling the speaker to emit the low-frequency sound having a frequency band in a low-frequency non-audible frequency band, so that the displacement of the diaphragm of the speaker reaches the preset value.

6. The air pressure adjustment method of the wrist-worn device according to claim 1, wherein determining whether the amplitude value is less than the preset amplitude threshold comprises:
determining a target preset amplitude threshold according to a current volume of the speaker based on a pre-established correspondence between a volume of the speaker and the preset amplitude threshold; and
determining whether the amplitude value is less than the target preset amplitude threshold.

7. The air pressure adjustment method of the wrist-worn device according to claim 6, wherein controlling the speaker of the wrist-worn device to emit the first sound comprises:
after receiving a command to turn on a pressure relief mode, controlling the speaker of the wrist-worn device to emit the first sound.

8. Air pressure adjustment apparatus for a wrist-worn device, applied to the wrist-worn device, the air pressure adjustment apparatus comprising:
a control module for controlling a speaker of the wrist-worn device to emit a first sound;
an analysis module for receiving a sound signal picked up by a microphone, and analyzing the sound signal to obtain a corresponding amplitude value;
a first determination module for determining whether the amplitude value is less than a preset amplitude threshold, and if so, activating a pressure relief module; and
the pressure relief module for performing pressure relief process of a rear cavity of the speaker.

9. An air pressure adjustment system for a wrist-worn device, applied to the wrist-worn device, the air pressure adjustment system comprising:
a memory configured to store a computer program; and
a processor configured to implement, when executing the computer program, the air pressure adjustment method of the wrist-worn device according to claim 1.

10. A wrist-worn device comprising a speaker, a microphone and the air pressure adjustment system of the wrist-worn device of claim 9.
